(19) United States
(12) Patent Application Publication
(10) Pub. No.: US 2020/0200942 A1
(43) Pub. Date: Jun. 25, 2020

(54) Opto-Electronics Module for a Downhole Gas Detection Sensor

(71) Applicant: Baker Hughes Oilfield Operations LLC, Houston, TX (US)

(72) Inventors: Andrew Main, Farnborough (GB); Stephen Day, Oxfordshire (GB); Ian Davidson, Oxfordshire (GB); James David Ratcliffe, Farnborough (GB)

(73) Assignee: Baker Hughes Oilfield Operations LLC, Houston, TX (US)

(21) Appl. No.: 16/721,503

(22) Filed: Dec. 19, 2019

Related U.S. Application Data
(60) Provisional application No. 62/783,455, filed on Dec. 21, 2018.

(51) Int. Cl. G01V 8/02

(52) U.S. Cl. CPC G01V 8/02

(57) ABSTRACT

A downhole logging tool includes a tool body housing an opto-electronics assembly. The opto-electronics assembly includes a circuit board and an opto-electronics module coupled to the circuit board and receiving control signals from the circuit board. The opto-electronics module includes a light source, a reference detector, a measurement detector, and a first beam splitter positioned with respect to the light source and the reference detector. The first beam splitter directs a first portion of light emitted from the light source into the reference detector and a second portion of the light emitted from the light source into an optical conduit. The opto-electronics module also includes a second beam splitter positioned with respect to the optical conduit and the measurement detector. The second beam splitter directs at least a portion of light received from the optical conduit into the measurement detector.

### CROSS REFERENCE TO RELATED APPLICATIONS

This application claims priority to U.S. Patent Application No. 62/783,455 filed Dec. 21, 2018 titled “OPTO-ELECTRONICS MODULE FOR A DOWNHOLE GAS DETECTION SENSOR”, the disclosure of which is incorporated herein by reference in its entirety.

### BACKGROUND

### 1. Field of Invention

This invention relates in general to equipment used in the hydrocarbon industry, and in particular, to a tool for measurement of downhole parameters in multiple phases.

### 2. Description of the Prior Art

In mixed phase oil/gas wells, it is often desirable to know the relative percentages of gas, oil and water at any one point in the well. This is particularly important in non-vertical or deviated wells, where the fluids tend to form layers along the wellbore and the composition of these layers becomes vital for optimizing the production of hydrocarbons from the well. Typical approaches to identifying the fluids have used capacitance and resistivity sensors to distinguish between the three fluids. Resistivity methods are used for detecting water, as water is significantly more conductive than oil or gas. However, capacitance methods are not very accurate for determining oil with respect to gas. An optical method using the refractive index of the fluids is relatively new technology in the field of downhole tools and has some shortcomings. While it is very efficient at distinguishing gas from oil, implementation of such technology comes with many constraints, including limited space and positioning.

### BRIEF DESCRIPTION OF THE DRAWINGS

Various embodiments in accordance with the present disclosure will be described with reference to the drawings, in which:

FIG. 1 illustrates a perspective view of such a downhole optical logging tool 100, in accordance with example embodiments.

FIG. 2 illustrates an internal view of the electronics portion of a tool body of a downhole logging tool, in accordance with example embodiments.

FIG. 3 illustrates a perspective view of the opto-electronics assembly, in accordance with example embodiments.

FIG. 4 illustrates another perspective view of the opto-electronics assembly, in accordance with example embodiments.

FIG. 5 illustrates an internal section view of the opto-electronics module, in accordance with example embodiments.

### SUMMARY

In an embodiment, a downhole logging tool includes a tool body housing an opto-electronics assembly. The opto-electronics assembly includes a circuit board and an opto-electronics module coupled to the circuit board and receiving control signals from the circuit board. The opto-electronics module includes a light source, a reference detector, a measurement detector, and a first beam splitter positioned with respect to the light source and the reference detector. The first beam splitter directs a first portion of light emitted from the light source into the reference detector and a second portion of the light emitted from the light source into an optical conduit. The opto-electronics module also includes a second beam splitter positioned with respect to the optical conduit and the measurement detector. The second beam splitter directs at least a portion of light received from the optical conduit into the measurement detector. The logging tool also includes an optical sensor optically coupled to the opto-electronics module to receive the second portion of the light emitted from the light source via the optical conduit. In some such embodiments, the optical conduit includes an optical fiber or a lens. In some embodiments, the logging tool further includes a plurality of such electronic assemblies arranged around the tool body. The opto-electronics module may be modular and removably coupled to the circuit board. Similarly, the opto-electronics assembly may be modular and removably coupled to the tool body. In some embodiments, the opto-electronics module includes a housing formed to hold the light source, reference detector, measurement detector, first beam splitter, and second beam splitter in fixed positions. In some embodiments, the optical sensor is on an outside of the tool body and optically couples to the optical conduit via a pressure sealed bulk head.

In another embodiment, an opto-electronics module for a downhole logging tool includes a housing, an optical connector coupled to the housing, a light source inside the housing, a reference detector inside the housing, a measurement detector inside the housing, and a beam splitter inside the housing positioned to direct a first portion of light emitted from the light source into the reference detector and a second portion of the light emitted from the light source into an optical conduit, the optical conduit traversing the optical connector. The opto-electronics module also includes a beam reflector inside the housing positioned to direct at least a portion of light received from the optical conduit into the measurement detector. In some such embodiments, the beam reflector is a second beam splitter positioned to direct a second portion of light received from the optical conduit out of the opto-electronics module. In some embodiments, the optical conduit includes an optical fiber or a lens. In some embodiments, an end of the optical fiber or lens at which light from the light source enters the optical fiber or lens is polished at an angle. The housing may be formed to hold the light source, reference detector, measurement detector, first beam splitter, and beam reflector in fixed positions. In some embodiments, the optical conduit is optically coupled to an external optical sensor, the optical sensor exposed to an external environment. In some embodiments, the measurement detector measures the intensity of the light received from the optical conduit to evaluate properties of an external environment. The intensity of the light is indicative of a liquid to gas composition in the external environment.

In another embodiment, a sensor system for a downhole logging tool includes an opto-electronics module and a sensor. The opto-electronics module includes a housing, an optical connector coupled to the housing, the optical connector providing an optical pathway, a light source inside the housing, a measurement detector inside the housing, and a beam reflector inside the housing positioned to direct at least a portion of light emitted from the light source into the optical conduit or direct at least a portion of light received from the optical pathway into the measurement detector. The sensor is coupled to the optical connector via a bulk head. The sensor includes a pressure plug on a first end, the pressure plug coupled to the bulk head, a sensor tip having an optical rod, in which at least a portion of the optical rod is exposed to an external environment, and an optical fiber extending from the pressure plug and into the sensor tip where the optical fiber is optically coupled to the optical rod at one end and the optical pathway on the other end. In some embodiments, the sensor device is modular and unpluggable from the bulk head. The measurement detector measures the intensity of the light reflected back from the optical rod. The housing may be formed to hold the light source, measurement detector, and beam reflector in fixed positions. In some embodiments, the sensor system further includes a plurality of opto-electronics modules and corresponding sensors arranged around a central axis of the downhole logging tool body.

### DETAILED DESCRIPTION OF THE INVENTION

The foregoing aspects, features and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

The system of the present technology provides a tool used to help identify the percentage of gas, water, and/or oil content present within a subterranean environment such as an oil or gas well. The tool may include one or more sensor devices that use optical methods and the refractive index of different well fluids (e.g., gas, water, oil) to determine the percentage of gas, compared to oil or water. The tool is made up of various parts and is designed to provide modularity and easy replaceability of its components, which means reduced downtime and operational costs. For example, the tool includes a compact and modular opto-electronics module for providing a light source and receiving returned light from the sensor.

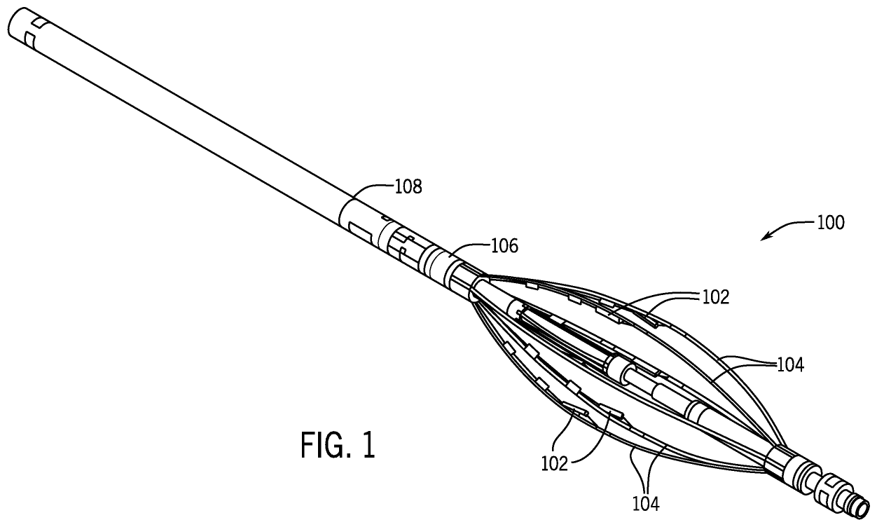

FIG. 1 illustrates a perspective view of such a downhole optical logging tool 100, in accordance with example embodiments. The tool 100 includes one or more sensors 102, such as those described in further detail below. Each of the sensors 102 is positioned on an exterior of the tool, at least when deployed, wherein the sensors 102 are exposed to well fluids. In some embodiments, the tool 100 includes a plurality of arms 104 which can expand radially outward depending on the size of the wellbore. The sensors 102 may be positioned on the arm 104 such as to be positioned away from each other and cover a large portion of a cross-section of the wellbore. In some cases, the fluid flow in the wellbore may be stratified (e.g., the fluid may not be completely uniform) and the plurality of sensors 102 in different positions can sample the fluid at different locations across the wellbore. For example, in a horizontal well, gas may accumulate near the top side of the horizontal wellbore. This may or may not be detected if only one sensor were present, but has a higher likelihood of being detected when there are multiple sensors 104 placed at different positions across a cross-section of the wellbore. The tool 100 may also include a sensor head portion 106, and each of the sensors may plug into the sensor head. The sensor head 106 acts as a bulk head between the electronics located inside the tool, which are at an ambient pressure, and the sensors 102, which are exposed to the downhole environment. In other words, the sensor head 106 may act as a feedthrough to allow sensors 104 to plug into it and then communicate with electronics in the dry part of the tool. A sensor 104 includes a pressure plug that couples to the sensor head 106.

Light is transmitted from a source inside the tool, such as a diode or laser, into an optical fiber. The other end of the fiber is typically coupled into a sensor tip, which has a conical shape and is immersed in well fluid. When the tip is immersed in oil or water, which have a refractive index similar to the optical fiber, a large portion of the light is passed out of the tip into the fluid and is lost. A light receiver within the tool measures little light returning back down the fiber. However, when the tip is located in gas, the refractive index is sufficiently different from the tip, such that total internal reflection can occur and a portion of the transmitted light will be reflected back into the fiber. The receiver measures a high level of light returning and thereby determines the makeup of the fluid. A technical challenge with this sensor design is to package the light source, receiver, associated splitters/mirrors, the drive, and sensor electronics into a sufficiently small space, so as to allow many sensors to be co-located within the tool.

As discussed further below, the downhole logging tool 100 of the present disclosure includes a tool body 108 that houses a compact and modular opto-electronics assembly. The opto-electronics assembly provides the light source and detector for the sensors 102.

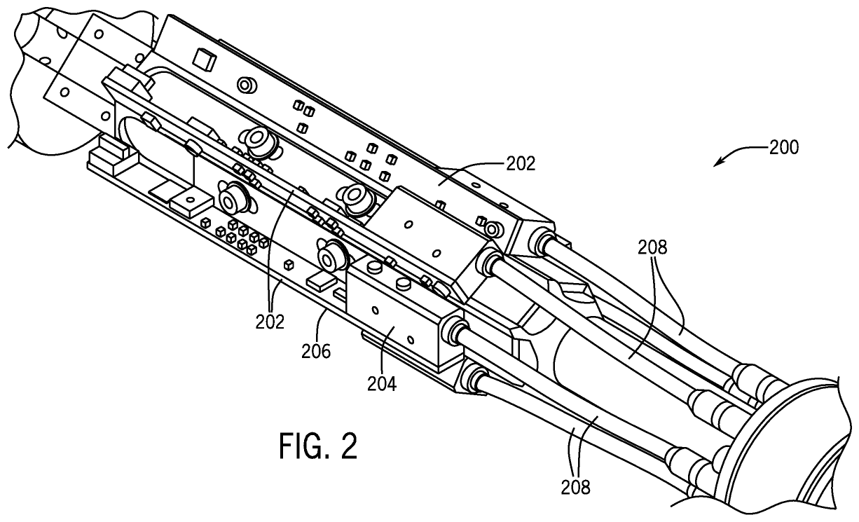

FIG. 2 illustrates an internal view of the electronics portion of the tool body 108 within such a downhole logging tool 100, in accordance with example embodiments. As illustrated, the tool 100 includes a plurality of opto-electronics assemblies 202. In some embodiments, the tool 100 includes a plurality of sensors 102 (as shown in FIG. 1) and a corresponding opto-electronics assembly 202 for each sensor 102. The opto-electronics assemblies 202 may be positioned around a central axis of the tool 100, such as corresponding to the positions of the sensors 102. In some embodiments, the sensors 102 and opto-electronics assemblies 202 may be arranged in a radially symmetric configuration.

An opto-electronics assembly 202 includes a circuit board 206 and an opto-electronics module 204 coupled to the circuit board 206. The opto-electronics module 204 may be modular and removably coupled to the circuit board 206 such as to be easily replaced or reused with another circuit board 206 or tool 100. Similarly, the entire opto-electronics assembly 202 may be modular and removably coupled to the tool. An opto-electronics module 204 may include an optical connector 208 that couples to the sensor/bulk head 106 and is optically coupled to a sensor 102. The sensor 102 includes a sensor tip that has an optical rod (e.g., sapphire rod) exposed to an external environment, such as well fluid. The opto-electronics module 204 provides a light source as well as a detector to receive the return light from the sensor 102, from which measurements are made to determine the liquid/gas composition of the well fluid.

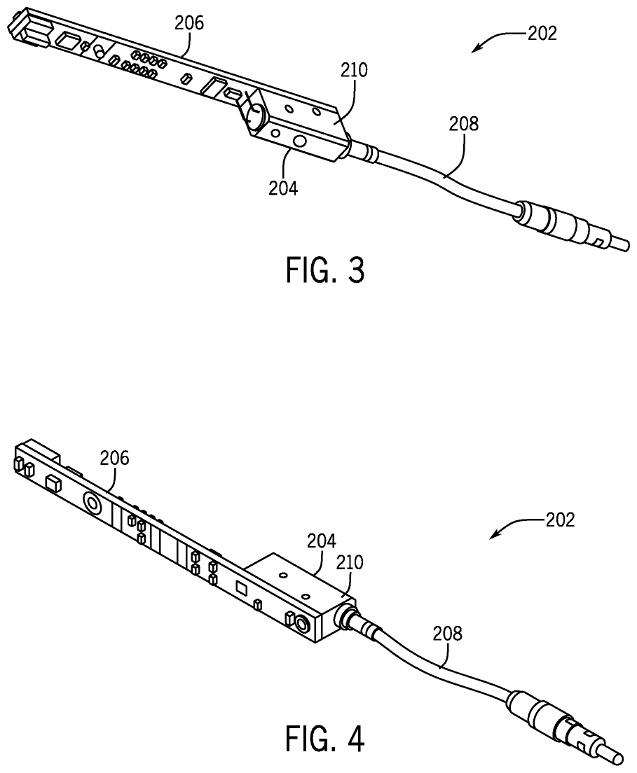

FIGS. 3 and 4 illustrate different views of the opto-electronics assembly 202, in accordance with example embodiments. The opto-electronics assembly 202 includes the opto-electronics module 204 mounted to the circuit board 206. The opto-electronics module 204 may include a housing 210 (e.g., small metal block) that houses and very accurately positions a number of optical components relative to each other. The circuit board 206 may be a low profile printed circuit board (PCB) that is physically coupled to the opto-electronics module 204 and electrically coupled to the optical components to provide drive signals to the light emitters and processes the light intensity returned on the sensors. The optical connector 208 transmits the light from the light source in the opto-electronics module 204 to the sensor and also transmits the reflected light captured by the sensor to the detector in the opto-electronics module 204.

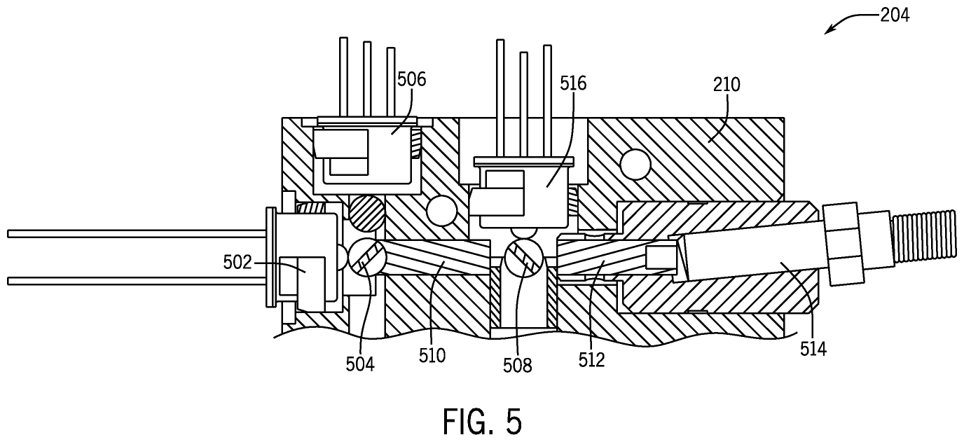

FIG. 5 illustrates an internal section view of the opto-electronics module 204, in accordance with example embodiments. In the illustrated embodiment, the opto-electronics module 204 includes a light source 502 a reference detector 506, a measurement detector 516, a first beam splitter 504, and a second beam splitter 508. The light source 502 may be a single light emitter such as an LED, a laser, or any other appropriate source. In some embodiments, the light signal emitted from the light source is frequency modulated. The first beam splitter is positioned at an angle with respect to the light source and the reference detector such that at least a portion of the light emitted from the light source is reflected into the reference detector 506 by the first beam splitter. Part of the light from the light source is directed towards the reference detector to be used as a reference signal, to calibrate the light intensity being produced by the emitter for any given well temperature. A second portion of the light is transmitted through the first beam splitter 504 and into an optical conduit 514 in the optical connector. The light then travels into the sensor via the optical connector and is emitted into an external environment through the sensor tip (e.g., sapphire rod). In some embodiments, the optical conduit 514 includes an optical fiber or a lens, and a lens may be positioned in front of the optical conduit. In some embodiments, the components may be configured alternatively such that the first beam splitter reflects part of the light from the light source 502 into the optical conduit and transmits another portion of the light through to the reference detector. In other embodiments, the components may be configured differently, but with the same object of delivering portions of light emitted by the light source to both a reference detector and the optical conduit for delivery to the sensor tip. In some embodiments, the opto-electronics module may not include a reference detector or the first beam splitter, which is used to provide feedback regarding the amount of light actually emitted from the source. The amount of light actually emitted by the source may be measured in another manner, such as by sensing the ambient temperature or other correlating factor.

Any light reflected back from the sensor tip strikes the second beam splitter 508 on returning to the opto-electronics module 204 via the optical conduit 514. A part of the returning light may pass through the second beam splitter 508 and is lost, while the other part is reflected into the measurement detector 516. The second beam splitter 508 may be positioned in various configurations with respect to the optical conduit 514 and the measurement detector to accomplish the objective of delivering at least a portion of the return light into the measurement detector 516. The second detector 516 measures the light signal returned from the sensor tip and evaluates whether the sensor tip is currently located in a liquid or gas, based on the properties of the received light. Data processing can then be performed to estimate the gas hold-up in the well. In some embodiments, while the coupling from the second lens into the optical fiber can be aligned co-axially, the back reflectance can be minimized if the end of the fiber is polished at an angle. The fiber is then held at a slight angle to correct for coupling losses due to the angle polished fiber.

In other embodiments, the configuration of the above-described components may vary. For example, a beam reflector inside the housing positioned to direct at least a portion of light emitted from the light source into the optical conduit or direct at least a portion of light received from the optical pathway into the measurement detector. This provides a degree of flexibility into arrangement of the components in order to accomplish this objective.

In some embodiments, the above-described components of the opto-electronics module 204 may be packaged within the housing 210. The housing 210 may be formed to hold and align the light source, reference detector, measurement detector, first beam splitter, and second beam splitter in fixed, precise positions. For examples, the housing 210 may have specific cavities formed in specific positions to hold specific components. In some embodiments, leads for the light source 502 and the and detectors 506, 516 may extend out from the housing to be electrically coupled to the circuit board 206 (FIGS. 3 and 4).

The opto-electronics assembly 202 is very compact and allows multiple sensors to be co-located and deployed out from the tool body. This can improve the accuracy of data processing to determine the gas hold-up measurement. The opto-electronics assembly 202 is also capable of driving a sensor with either a single optical fiber, or a bundle of multiple fibers. Reliability of the assembly may also be improved, as the optical components are safely located within a single small package, rather than having individual discrete components and couplers connected by delicate fibers. Both the opto-electronics module 204 and the overall opto-electronics assembly 202 can be easily replaced in case of failure. The defective module 204 or assembly 202 is unplugged from the optical sensor 104 and from the telemetry electronics and can then be replaced with a new module within minutes. The modularity of the system provides the added advantage that the same opto-electronics package can be used in multiple different types of logging tool, if a gas sensor is required.

In various embodiments, various instrumentation units and data collection units may be utilized that may include a digital and/or an analog system. For example, the tool that measures the spectrum and its associated analytical components may include digital and/or analog systems. Furthermore, various surface and wellbore components not illustrated for clarity may also use a variety of digital and/or analog systems. The system may have components such as a processor, storage media, memory, input, output, communications link (wired, wireless, optical or other), user interfaces (e.g., a display or printer), software programs, signal processors (digital or analog) and other such components (such as resistors, capacitors, inductors and others) to provide for operation and analyses of the systems and methods disclosed herein. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery, magnet, electromagnet, sensor, electrode, transmitter, receiver, transceiver, antenna, controller, optical unit, electrical unit or electromechanical unit) may be included in support of the various aspects discussed herein or in support of other functions beyond this disclosure.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A downhole logging tool, comprising:
a tool body housing an opto-electronics assembly, the opto-electronics assembly comprising
a circuit board; and
an opto-electronics module coupled to the circuit board and receiving control signals from the circuit board, the opto-electronics module comprising:
a light source;
a reference detector;
a measurement detector;
a first beam splitter positioned with respect to the light source and the reference detector, wherein the first beam splitter directs a first portion of light emitted from the light source into the reference detector and a second portion of the light emitted from the light source into an optical conduit; and
a second beam splitter positioned with respect to the optical conduit and the measurement detector, wherein the second beam splitter directs at least a portion of light received from the optical conduit into the measurement detector; and
an optical sensor optically coupled to the opto-electronics module to receive the second portion of the light emitted from the light source via the optical conduit.

2. The downhole logging tool of claim 1, wherein the optical conduit includes an optical fiber or a lens.

3. The downhole logging tool of claim 1, further comprising a plurality of opto-electronics assemblies arranged around the tool body.

4. The downhole logging tool of claim 1, wherein the opto-electronics module is modular and removably coupled to the circuit board.

5. The downhole logging tool of claim 1, wherein the opto-electronics assembly is modular and removably coupled to the tool body.

6. The downhole logging tool of claim 1, wherein the opto-electronics module includes a housing formed to hold the light source, reference detector, measurement detector, first bean splitter, and second beam splitter in fixed positions.

7. The downhole logging tool of claim 1, wherein the optical sensor is on an outside of the tool body and optically couples to the optical conduit via a pressure sealed bulk head.

8. An opto-electronics module for a downhole logging tool, comprising:
a housing;
an optical connector coupled to the housing;
a light source inside the housing;
a reference detector inside the housing;
a measurement detector inside the housing;
a first beam splitter inside the housing positioned to direct a first portion of light emitted from the light source into the reference detector and a second portion of the light emitted from the light source into an optical conduit, the optical conduit traversing the optical connector; and
a beam reflector inside the housing positioned to direct at least a portion of light received from the optical conduit into the measurement detector.

9. The opto-electronics module of claim 8, wherein the beam reflector is a second beam splitter positioned to direct a second portion of light received from the optical conduit out of the opto-electronics module.

10. The opto-electronics module of claim 8, wherein the optical conduit includes an optical fiber or a lens.

11. The opto-electronics module of claim 10, wherein an end of the optical fiber or lens at which light from the light source enters is polished at an angle.

12. The opto-electronics module of claim 8, wherein the housing is formed to hold the light source, reference detector, measurement detector, first beam splitter, and beam reflector in fixed positions.

13. The opto-electronics module of claim 8, wherein the optical conduit is optically coupled to an external optical sensor, the optical sensor exposed to an external environment.

14. The opto-electronics module of claim 8, wherein the measurement detector measures the intensity of the light received from the optical conduit to evaluate properties of an external environment.

15. The opto-electronics module of claim 14, wherein the intensity of the light indicative of a liquid to gas composition in the external environment.

16. A sensor system for a downhole logging tool, comprising:
an opto-electronics module, comprising:
a housing;
an optical connector coupled to the housing, the optical connector providing an optical pathway;
a light source inside the housing;
a measurement detector inside the housing;
a beam reflector inside the housing positioned to direct at least a portion of light emitted from the light source into the optical conduit or direct at least a portion of light received from the optical pathway into the measurement detector; and
a sensor device coupled to the optical connector via a bulk head, the sensor device comprising:
a pressure plug removably coupled to the bulk head;
a sensor tip comprising an optical rod, wherein at least a portion of the optical rod is exposed to an external environment; and
an optical fiber extending from the pressure plug and into the sensor tip where the optical fiber is optically coupled to the optical rod at one end and the optical pathway on the other end.

17. The sensor system of claim 16, wherein the sensor device is modular and unpluggable from the bulk head.

18. The sensor system of claim 16, wherein the measurement detector measures the intensity of the light reflected back from the optical rod.

19. The sensor system of claim 16, wherein the housing is formed to hold the light source, measurement detector, and beam reflector in fixed positions.

20. The sensor system of claim 16, further comprising a plurality of opto-electronics modules and corresponding sensors arranged around a central axis of the downhole logging tool body.
